(19) United States
(12) Patent Application Publication
(10) Pub. No.: US 2018/0319262 A1
(43) Pub. Date: Nov. 8, 2018

(54) Magnetic Sun Shade

(71) Applicant: Anthony M. Cerasani, Gilbert, AZ (US)

(72) Inventor: Anthony M. Cerasani, Gilbert, AZ (US)

(21) Appl. No.: 15/970,753

(22) Filed: May 3, 2018

Related U.S. Application Data
(60) Provisional application No. 62/501,010, filed on May 3, 2017.

(51) Int. Cl. B60J 11/08

(52) U.S. Cl. CPC B60J 11/08

(57) ABSTRACT

A sun shade includes a substrate and a folding line formed in the substrate. A first attachment mechanism is disposed over the substrate on a first side of the folding line. A second attachment mechanism is disposed over the substrate on a second side of the folding line. The first attachment mechanism and second attachment mechanism can be located symmetrically across the folding line. The attachment mechanisms can include magnets and ferrous material. A third attachment mechanism is separate from the sun shade and configured to attach to the first attachment mechanism. The substrate can include a flap oriented substantially perpendicular to the folding line.

### CLAIM TO DOMESTIC PRIORITY

The present application claims the benefit of U.S. Provisional Application No. 62/501,010, filed May 3, 2017, which application is incorporated herein by reference.

### FIELD OF THE INVENTION

The present invention relates in general to sun shades, and more particularly, to a vehicle sun shade utilizing attachment mechanisms for convenient deployment and storage.

### BACKGROUND OF THE INVENTION

Sun shades are commonly used in vehicles when the vehicle is parked outside. Especially in the summer months, the sun shining directly on a vehicle can heat up the inside of a vehicle to extreme temperatures. The heat can cause driver and passengers discomfort or, worse yet, injury from contact with heated car parts burning skin. Sun shades are placed in windows when a car is parked in the sun to reduce the amount of sunlight that enters the vehicle by blocking or bouncing the sun's rays.

In many parts of the world, a sun shade is a necessary piece of equipment found in every vehicle. Sun shades today come in a variety of form factors with various storage and deployment mechanisms. Many simply fold up accordion style, and there is no convenient storage location in most cars. Others are twisted into a figure eight and folded, which can be tricky and can pop undone without notice. Sun shades can be difficult to fold up, and do not always remain properly folded. Therefore, a need exists for a vehicle sun shade that fits properly, stays in place, doesn't sag, is easy to fold up, and can reliably remain in the folded state.

### BRIEF DESCRIPTION OF THE DRAWINGS

FIG. 1 illustrates a folding sun shade with embedded attachment mechanisms to maintain the folds;

FIGS. 2a-2g illustrate folding the sun shade;

FIGS. 3a-3c illustrate installing the sun shade in a vehicle with the sun shade held in place by attachment mechanisms;

FIGS. 4a and 4b illustrate an alternative attachment mechanism layout;

FIGS. 5a and 5b illustrate a sun shade split into two parts;

FIGS. 6a-6i illustrate a sun shade mounted to the inside of a windshield for convenient storage and quick deployment;

FIGS. 7a and 7b illustrate a flap for covering a space between two sun shade parts; and

FIGS. 8a and 8b illustrate alternative mounting configurations for the windshield mounted sun shade.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

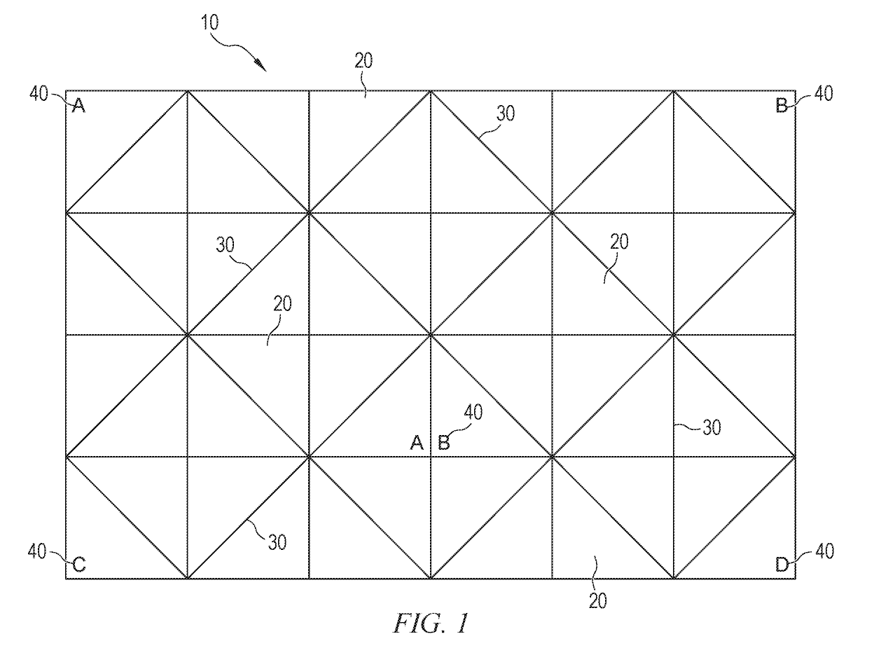

FIG. 1 illustrates a sun shade 10. Sun shade 10 is configured for insertion into a car windshield so that the car interior can be protected from sunlight when parked, or for other purposes. Sun shade 10 can be configured for use in other windows, such as the side or rear windows of a vehicle, or windows in a structure such as house or office building. In some embodiments, sun shade 10 is made of a translucent material so that incoming light is reduced without eliminating visibility through the shade.

Sun shade 10 is generally flat and can be formed from any appropriate material for blocking or reflecting sunlight. In some embodiments, sun shade 10 is formed from a sheet of cardboard, fabric, polymer, plastic, metal foil, mesh netting, or combinations thereof. In one embodiment, a stiff substrate material is coated with a reflective material to improve sunlight blocking capabilities of sun shade 10. In another embodiment, cardboard or another stiff material is sewn within a reflective fabric.

Sun shade 10 includes a plurality of horizontal, vertical, and diagonal folding lines 30 that separate the sun shade into a plurality of sections 20. In some embodiments, folding lines 30 are scored into the substrate material of sun shade 10. In other embodiments, folding lines 30 are laser etched or mechanically etched into the substrate material. In one embodiment, a press or heat press is used to mold folding lines 30. In some embodiments, folding lines 30 are etched in a different pattern on the two faces of sun shade 10, depending on which direction the recommended folding pattern calls for that portion of sun shade 10 to be folded. In one embodiment, sections 20 are each formed of a separate piece of stiff substrate material, and the separate pieces of substrate material are held together by a flexible material at folding lines 30.

Folding lines 30 have a weaker structural integrity than the stiffer sections 20. Folding lines 30 exist along the manufacturer recommended folding pattern for storing sun shade 10. A user attempting to fold up sun shade 10 can apply slight folding pressure to the sun shade and the shade will automatically fold along the folding lines placed by the manufacturer for optimal folding. Different folding or rolling methods may be used for different sun shade 10 materials, or for any reason. In some embodiments, the differing physical aspects of folding lines 30 relative to sections 20 are not easily visible on sun shade 10. Folding lines 30 can be printed or otherwise marked for easier visibility of the folding lines.

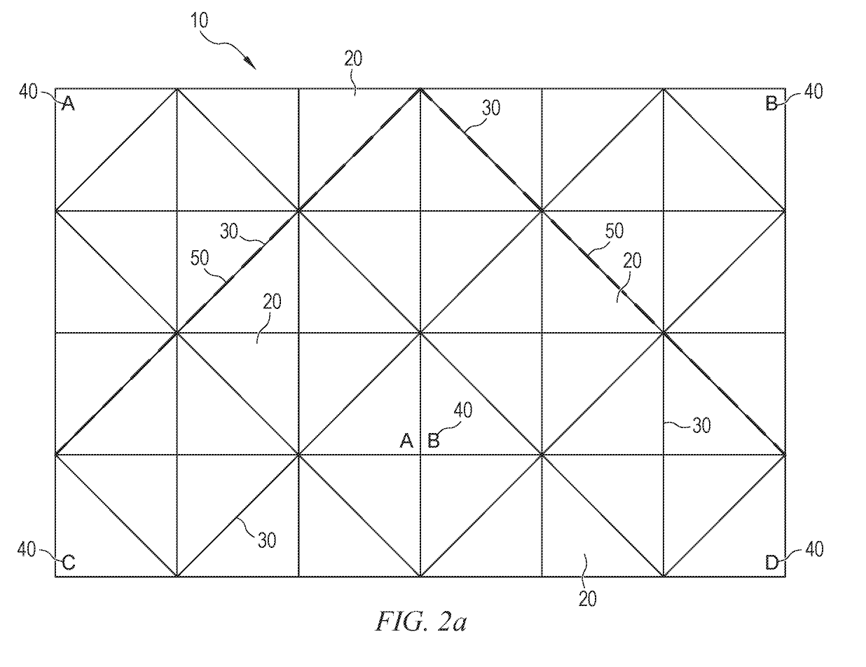

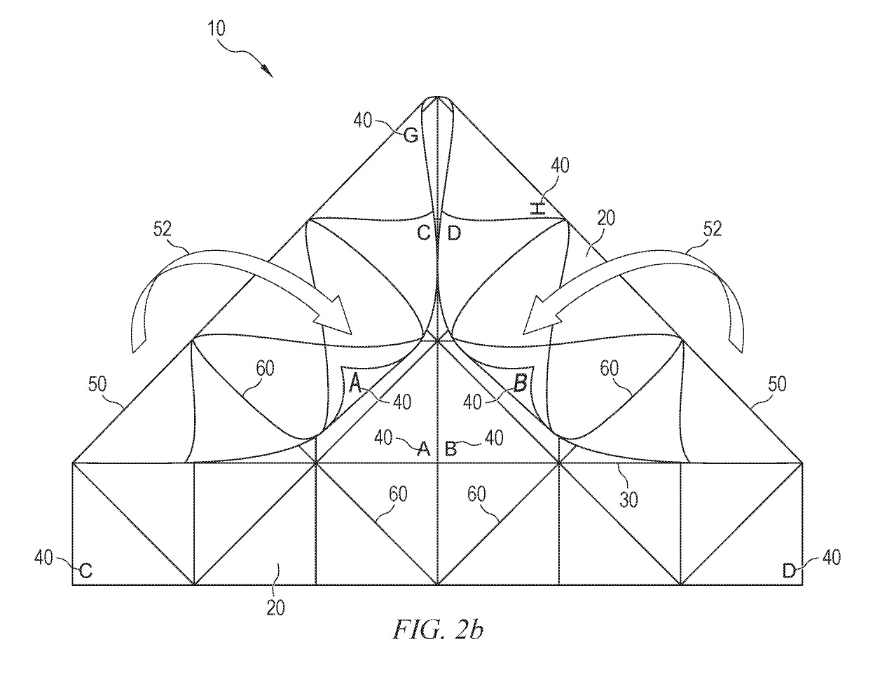

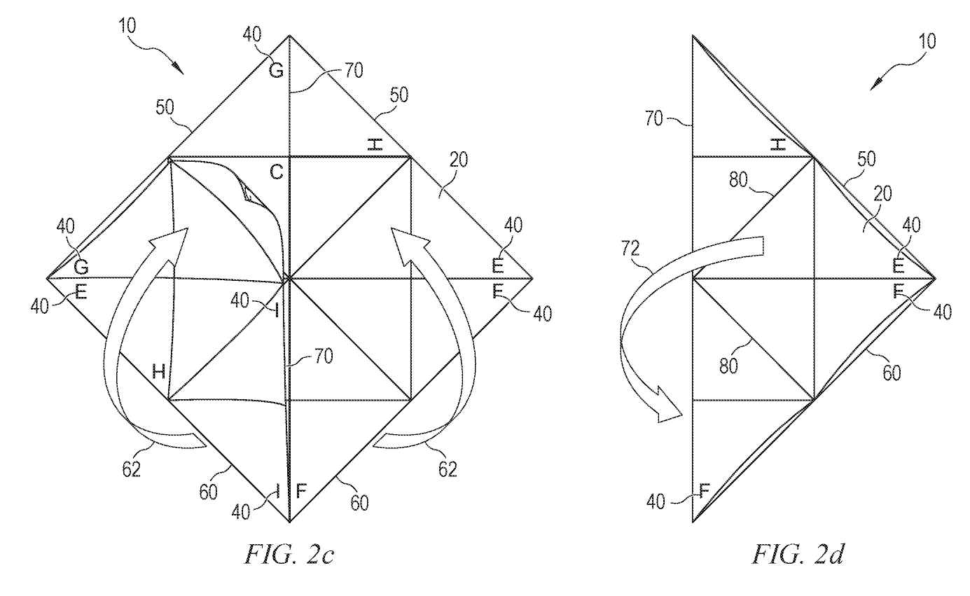

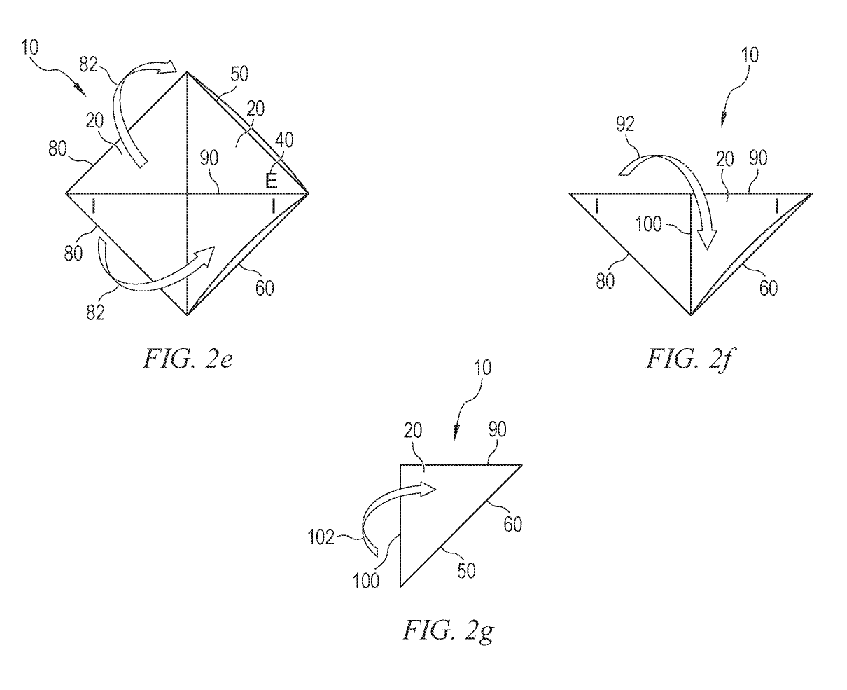

FIGS. 2a-2g illustrate folding sun shade 10. Sun shade 10 optionally includes numbers, letters, or other indicators 40 printed on the two faces of the sun shade. Indicators 40 are illustrated as letters to reduce confusion with reference numbers in the figures. The letters of indicators 40 are printed to explain the order of folds that the manufacturer suggests for easiest folding and storage of sun shade 10.

The A-A fold is the recommended first fold, ‘A’ being the first letter of the alphabet. That is, a user of sun shade 10 should grab the corner with ‘A’ printed and fold said corner down to the other ‘A’ printed in the middle of the sun shade. Folding so that the two letters ‘A’ meet is referred to as the A-A fold. The B-B fold can occur simultaneously with or after the A-A fold. The B-B fold is essentially identical, but on the opposite side of sun shade 10 from, the A-A fold. The A-A and B-B folds occur along lines 50 in FIG. 2a.

FIG. 2b illustrates sun shade 10 after a user has performed the A-A and B-B folds along folding lines 50. In some embodiments, sun shade 10 includes attachment mechanisms that hold the recommended folds. The folds can be held together by magnets, in which case the A's and B's in FIG. 2a each have respective magnets, or magnets and ferrous material, that attract to keep the folds together in FIG. 2b. In other embodiments, the folds can be held together by Velcro®, buttons, or other attachment mechanisms on sun shade 10 that a user brings together with each fold of the sun shade. Respective portions of the attachment mechanism are aligned symmetrically across the folding line for the particular fold being held. Therefore, when performing the fold, the sides of the attachment mechanism come into contact, or at least within the range required for attachment.

Arrows 52 indicate the general motion that occurred in folds A-A and B-B between FIGS. 2a and 2b. The reverse side of sun shade 10, now visible due to the A-A and B-B folds being completed, reveals the letters C and D, which are the next two folds recommended. Users know to fold C and D next because C and D are the next two letters in the alphabet after A and B. Again, numbers could be used instead, but are not used in this example to reduce confusion with reference numbers in the figures. The letters G and H are also visible after the A-A and B-B folds are completed, and will come into play subsequently. Next, however, the C-C and D-D folds will occur across folding lines 60.

FIG. 2c illustrates sun shade 10 after the C-C and D-D folds are complete across folding lines 60. Arrows 62 illustrate the motion that sun shade 10 experienced during the folding of lines C-C and D-D. As with A-A and B-B folds, the sun shade optionally includes attachment mechanisms to hold the C-C and D-D folds in place. In some cases, the C-C and D-D folds can piggyback on the attachment mechanisms for folds A-A and B-B. For instance, the top-left corner letter A in FIG. 2a could be a magnet that attaches to a piece of ferrous material under the other letter A. The attachment mechanism for the C fold could be a piece of ferrous material that is off-center from the printed letter C in the bottom-left corner, so that when fold C-C is performed the ferrous material is aligned with and attaches to the magnet from the first letter A. The locations of attachment mechanisms around sun shade 10 can be configured as desired so that each fold is able to be held in place. The attachment mechanisms can be Velcro, button, clip, magnet, metal, etc.

In FIG. 2c, the E-E fold is next, and folding line 70 for the E-E fold is vertically oriented down the center of sun shade 10. The fold is made away from the viewer, although could occur in either direction. If desired the letters E can be printed on the reverse side, or a symbol can be used to indicate that the E's are recommended to be folded away. Again, a Velcro®, button, or magnetic attachment mechanism can be used to secure the E-E fold.

FIG. 2d illustrates sun shade 10 after the E-E fold is completed. Arrow 72 indicates the motion of sun shade 10 to perform the E-E fold across line 70. Folding lines 80 for the F-F and G-G fold are illustrated. In one embodiment, the F-F fold occurs toward the viewer, while the G-G fold occurs away from the user. The G's are printed on the reverse side to indicate a backward fold, although another mechanism to notify users of the recommended folding direction could be used in other embodiments. The F-F and G-G folds could also occur in the same direction.

FIG. 2e illustrates the F-F and G-G folds completed across folding lines 80 as indicated by arrows 82. Folding line 90 for fold H-H is visible. The H-H fold is recommended to be performed away from the viewer, so the H's are printed on the back side of sun shade 10 in the view of FIG. 2e. FIG. 2f illustrates the H-H fold completed across folding line 90, as indicated by arrow 92, and folding line 100 for the upcoming I-I fold.

FIG. 2g illustrates sun shade 10 after the I-I fold is completed across folding line 100, as indicated by arrow 102. Fold I-I completes the folding of sun shade 10 into a nice tidy triangle. Each of the folds is held in place by magnets, buttons, Velcro®, or another attachment mechanism. The small triangle is easily stored in a glove compartment, under a seat, or another small compartment in a vehicle. The attachment mechanisms that hold the folds in place reduce the likelihood of sun shade 10 inadvertently unfurling itself in the vehicle, which can be a nuisance for the user and occurs with many prior art sun shades. The folded sun shade 10 can also be placed in a pouch and shut by a zipper, Velcro®, button, magnet, metal, or other attachment mechanism.

While a triangular fold is illustrated, the folding could also be square, rectangular, polygonal, or any other desired folding pattern. The folding can be performed in more or less steps depending on the desired complexity, storage size, or shade size. Sun shade 10 can alternatively be rolled. If desired, sun shade 10 can be folded after rolling or rolled after folding, and the embedded attachment mechanisms will keep the sun shade properly stored. In one embodiment, the folding pattern is a simple accordion style fold, and the attachment mechanisms keep the folding secure. The user unfolds sun shade 10 in the reverse order for installation in a vehicle's windshield. The attachment mechanisms that hold the folds are undone without having to apply too much pressure to limit the amount of work in unfolding sun shade 10.

Sun shade 10 is trimmed to a custom fit for different vehicles in various embodiments. Specific makes, models, and years of vehicles will have differing windshield geometries. A manufacturer of sun shades measures the inside of a particular vehicle windshield using a laser scanner, measuring tape, based on CAD files, or other appropriate means, and then can cut sun shade 10 into nearly the exact shape of the windshield. Custom fit sun shades 10 will be easier to install and more efficient at blocking sunlight.

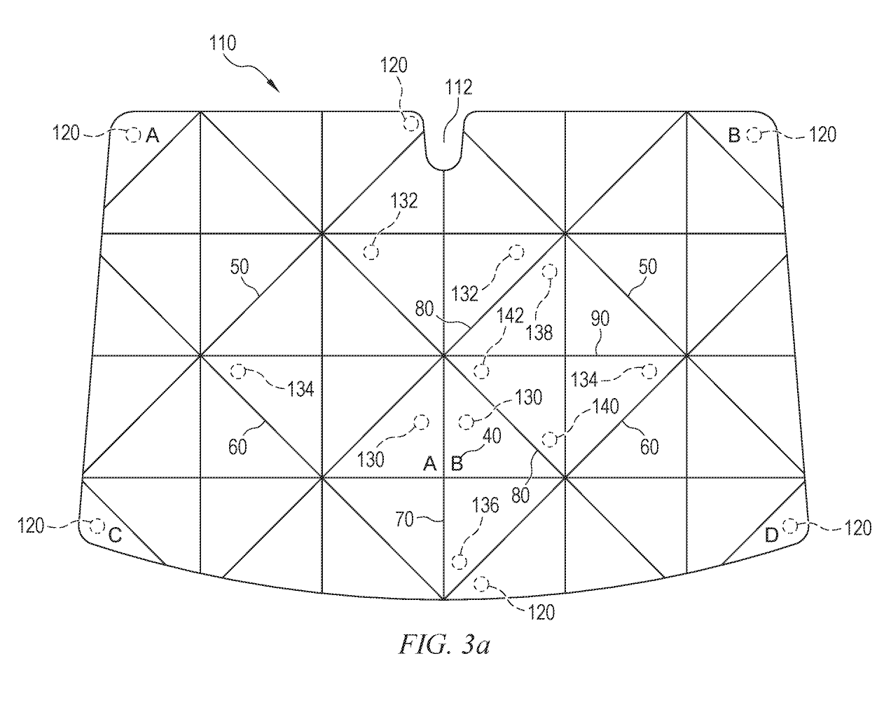

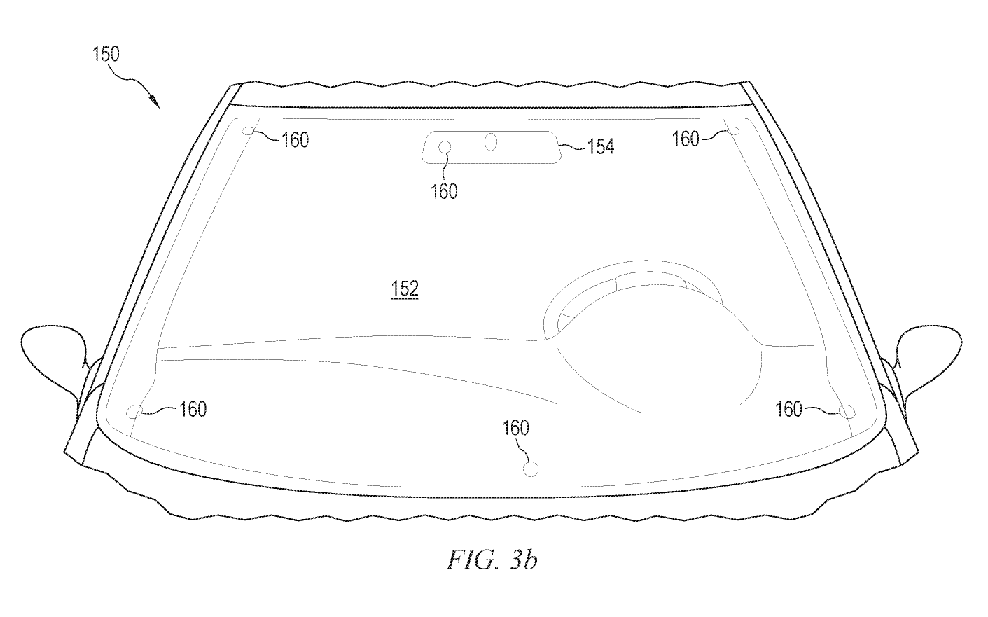

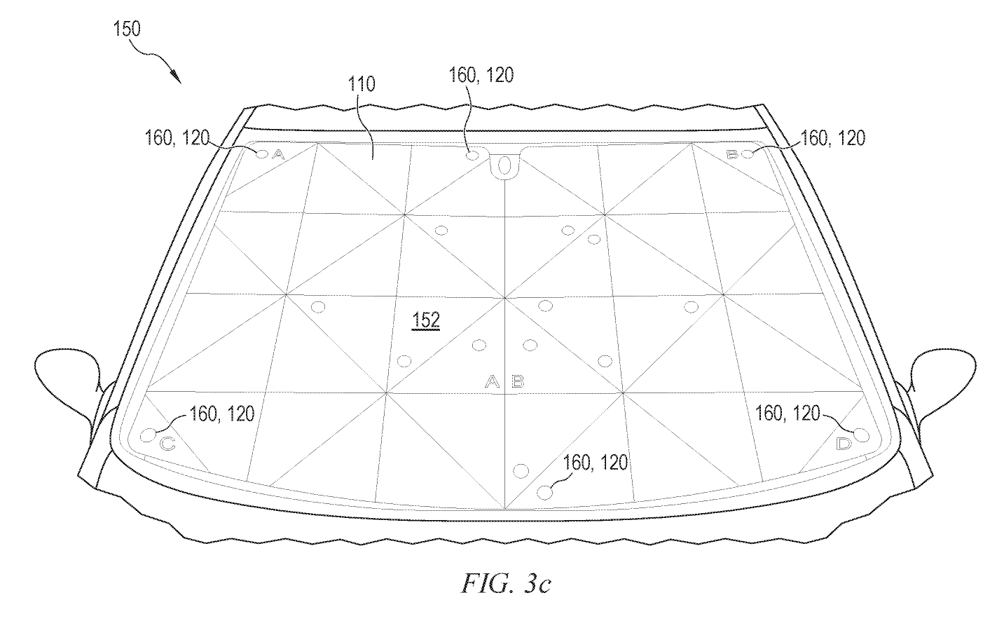

FIG. 3a illustrates a sun shade 110, which is custom cut from sun shade 10. Sun shade 10 can be cut into the custom-fit sun shade 110 by a laser cutter, scissors, razor blade, a die press, or any other appropriate means. Most windshields are approximately symmetrical, so the center line of the uncut sun shade 10 remains centered on the cut sun shade 110. For some sun shades, the center line for the uncut sun shade 10 does not remain in the center after cutting. Other embodiments use a dual center line variation. In some embodiments, sun shade 110 is manufactured to shape rather than being cut to shape from a larger shade. Sun shade 110 includes a cutout 112 for the rear view mirror if necessary.

In addition to using attachment mechanisms for keeping the folds secure for storage, the attachment mechanisms can be used for holding the sun screen in place in a windshield. Attachment mechanisms 120 in FIG. 3a illustrate attachment mechanisms along the top and bottom of sun shade 110 that are used to hold the sun shade onto a windshield. Attachment mechanisms 120 can have a shared use both in folding sun shade 110 and for holding the sun shade in a windshield. Some attachment mechanisms 120 may be placed on the sun shade 110 specifically to hold the sun shade in a windshield and are not relevant to folding. Attachment mechanisms 120 can be attached to a surface of sun shade 110 or embedded within the sun shade material.

The folding lines that were made in sun shade 10 are still valid for the custom fit shade 110. However, since the corners may have been cut off, attachment mechanisms 120 may need to be configured to not be at the extreme corners of the sun shade. The attachment mechanisms may be positioned inward from the corners of sun shade 10 sufficiently such that the attachment mechanisms are not cut off for any shape of sun shade 110 that a manufacturer desires to make. That way, a single attachment mechanism 120 configuration remains valid for each model of sun shade 110. In another embodiment, sun shades 10 are made with different configurations for general sizes of windshields, e.g., a different configuration for cars and trucks.

Sun shade 110 includes attachment mechanisms 130 disposed on or embedded within the sun shade for holding the A-A and B-B folds. Attachment mechanisms 130 are placed symmetrically across line 50 from the attachment mechanisms 120 for the A and B corners. When folding sun shade 110 along folding lines 50 for the A-A and B-B folds, attachment mechanisms 120 in the top-left and top-right corners will end up being near attachment mechanisms 130. In one embodiment, attachment mechanisms 120 are magnets, and attachment mechanisms 130 are pieces of metal attracted to the magnets.

Attachment mechanisms 132 are disposed on or embedded in sun shade 110 symmetrically across lines 60 from the bottom-left and bottom-right attachment mechanisms 120 to hold the C-C and D-D folds. Attachment mechanisms 134 are located symmetrically across line 70 to hold the E-E fold. The G-G fold can be held in place by attachment mechanism 136 placed symmetrically across the lower line 80 from attachment mechanisms 134. The G-G fold can be held in place with the attachment mechanisms 132 and an attachment mechanism 138 that is placed symmetrically across the top line 80 from mechanisms 132. Attachment mechanism 140 is added symmetrically across line 90 from mechanism 138 for holding the H-H fold. Mechanism 142 is placed symmetrically across line 100 from mechanism 134 so that those mechanisms can hold the I-I fold.

Each of the attachment mechanisms can be either a magnet or a piece of metal. In another embodiment, each of the attachment mechanisms can be a magnet with polarities oriented for proper attachment. The attachment mechanisms can also be Velcro, buttons, another type of attachment mechanism mentioned above or below, or any other suitable attachment mechanism. Not every fold needs specific attachment mechanisms for that fold. A strategic placement could allow more reuse of the same magnets to hold multiple folds. Alternatively, having attachment mechanisms for only every other fold rather than every single fold could be sufficient.

A user of sun shade 110 places attachment mechanisms in his or her vehicle windshield that correspond to attachment mechanisms 120 on the sun shade. FIG. 3b illustrates a vehicle 150 with windshield 152. Windshield 152 has a rear view mirror 154 attached at the top-center of the windshield. Attachment mechanisms 160 are mounted along the top and bottom edges of windshield 152. Any pattern of attachment mechanisms 120 and 160 is usable, but the patterns should approximately correspond with each other.

To install sun shade 110 in windshield 152, as illustrated in FIG. 3c, a user unfolds the sun shade and attaches attachment mechanisms 120 on sun shade 110 to attachment mechanisms 160 on the windshield. Engaging attachment mechanisms 120 with attachment mechanisms 160 can be as simple as moving an unfolded sun shade 110 near windshield 152 and allowing the magnetic attraction to pull the sun shade to the windshield. In non-magnetic embodiments, the user may need to insert a hook through a loop, press two parts of a button together, or otherwise act on the attachment mechanisms. Attachment mechanisms 120 and 160 are configured to properly line up the sun shade 110 within the windshield for optimal sun blocking.

Attachment mechanisms 160 can be thin and nearly flush with the inside of windshield 152. In other embodiments, attachment mechanisms 160 are disposed on the outside of windshield 152 or embedded within the windshield. Attachment mechanisms 160 may also be small pillars or posts, or otherwise include a height to provide a standoff between sun shade 110 and the windshield. Attachment mechanisms 160 on the windshield can have metal pieces for attraction to magnets on sun screen 110, magnets for attraction to metal pieces or other magnets on the sun screen, buttons, hooks, clasps, latches, etc. to allow attachment of the sun shade.

In one embodiment, attachment mechanisms 160 are metal slugs, and attachment mechanisms 120 are magnets. After unfolding sun shade 110, the user moves the sun shade toward windshield 152, and the magnets snap to the metal slugs on the windshield. The magnetic attraction holds sun shade 110 in approximately perfect position with little effort on the part of the user. The user simply has to get sun shade 110 near windshield 152, and the magnets do the rest of the work. Attachment mechanisms 120 and 160 could also be opposing sides of a Velcro® mechanism between windshield 152 and sun shade 110, or hooks on the windshield that are inserted into openings in the sun shade.

Attachment mechanisms 160 are attached to the inside of windshield 152 by an adhesive, by suction cups, or by another appropriate means. Sun shade 110 itself can be used as a template for placing attachment mechanisms 160 in windshield 152. A user first attaches attachment mechanisms 160 to attachment mechanisms 120 on the unfolded sun shade 110 while the sun shade is not installed on windshield 152. If there is an adhesive backing to attachment mechanisms 160, the backing is removed to expose the adhesive. The user places sun shade 110 up to windshield 152 as desired to be installed during normal use, and the adhesive on attachment mechanisms 160 sticks to the windshield in the proper places for installation of the sun shade. In other embodiments, a separate template formed from paper, cloth, plastic, or another material is used to place attachment mechanisms 160 on the windshield 152. Attachment mechanisms 160 can come pre-placed on a template that is used to install the mechanisms on windshield 152, or the user can put the attachment mechanisms on the template after purchase. In another embodiment, the template includes cut-outs and a user installs attachment mechanisms 160 on windshield 152 through openings in the template.

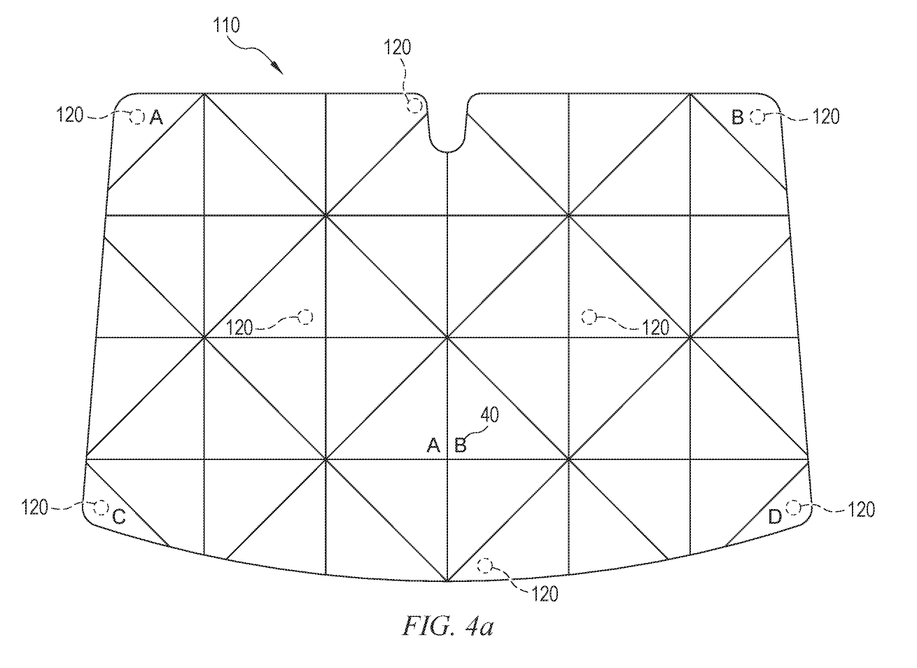

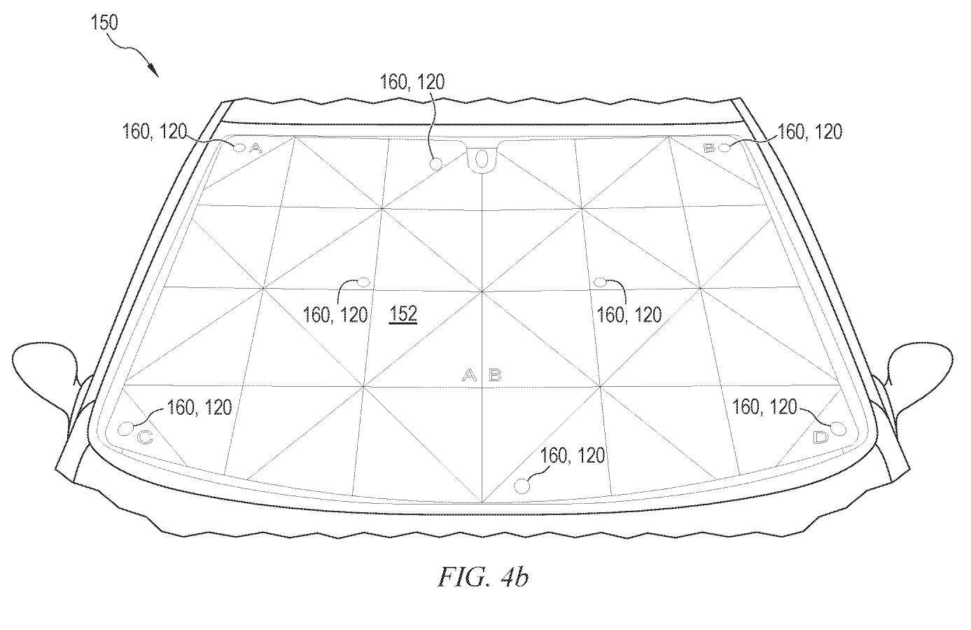

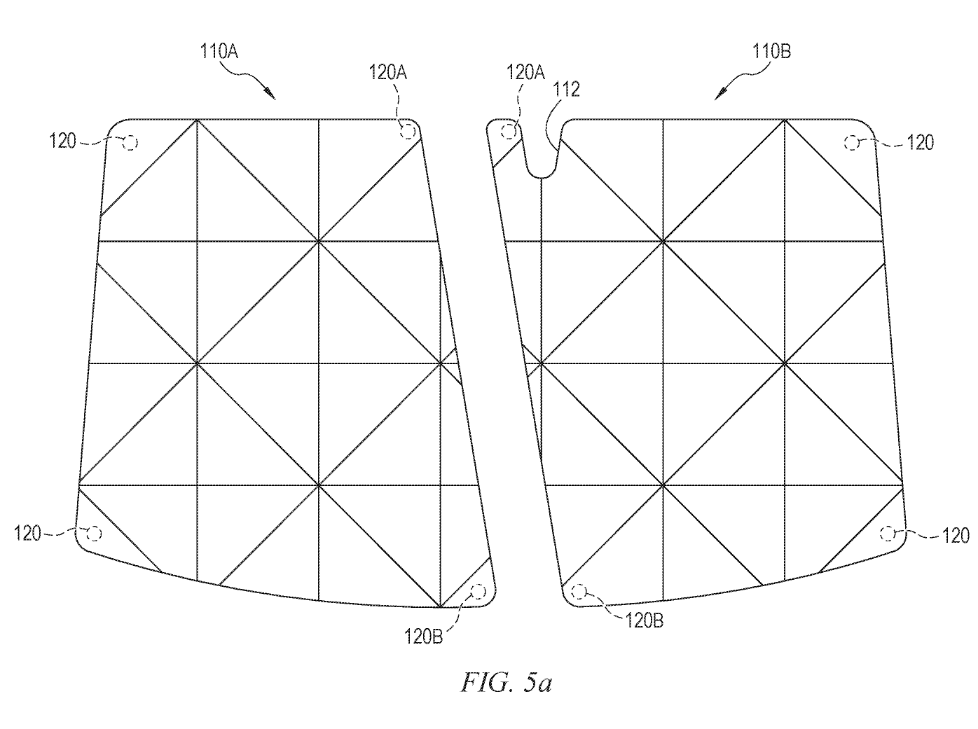

FIGS. 4a and 4b illustrate an alternative attachment mechanism pattern for holding sun shade 110 on windshield 152. Attachment mechanisms can be along top, bottom, or the sides of the windshield. Attachment mechanisms can also be placed in toward the middle of sun shade 110 and windshield 152 if desired. Attachment mechanisms can be placed at any place on windshield 152 and sun shade 110, and any combination of locations of attachment mechanisms can be used. In some embodiments, attachment mechanisms are only used along the top of the windshield and sun shade, and the bottom of the sun shade is held in place by being in the corner where the dashboard meets the windshield.

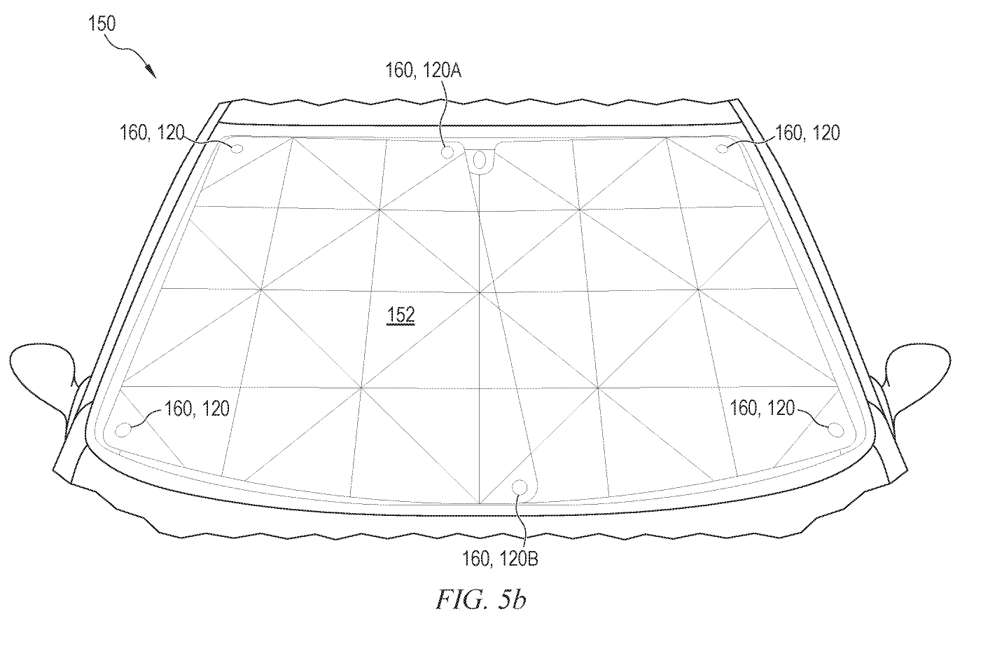

FIGS. 5a and 5b illustrate a split sun shade 110 that is two separate pieces 110a and 110b. Splitting sun shade 110 into two pieces can make installation and removal from windshield 152 easier, especially for larger windshields. Folding up the windshield is more manageable within a vehicle where there may not be room to easily fold a sun screen the size of the entire windshield.

The sizes of sun shade halves 110a and 110b in FIG. 5a are larger than exactly half of sun shade 110. The halves 110a and 110b are configured to overlap when installed on a windshield. The attachment mechanisms 120a are configured to attach to a common attachment mechanism 160 in windshield 152, as are the attachment mechanisms 120b. In other embodiments, the windshield halves do not overlap and separate attachment mechanisms 160 are used for each sun shade portion. Rear view mirror cutout 112 can be included with one of the two halves 110a or 110b, or each half can include a rear view cutout. In other embodiments, the split of the windshield is through rear view mirror cutout 112 such that neither half 110a nor 110b has a whole rear view mirror cutout.

FIG. 5b illustrates sun shade halves 110a and 110b installed in windshield 152. While sun shade 110 is illustrated as split into two sections, any number of sections can be used and the split between sections can be vertical, horizontal, or any other direction.

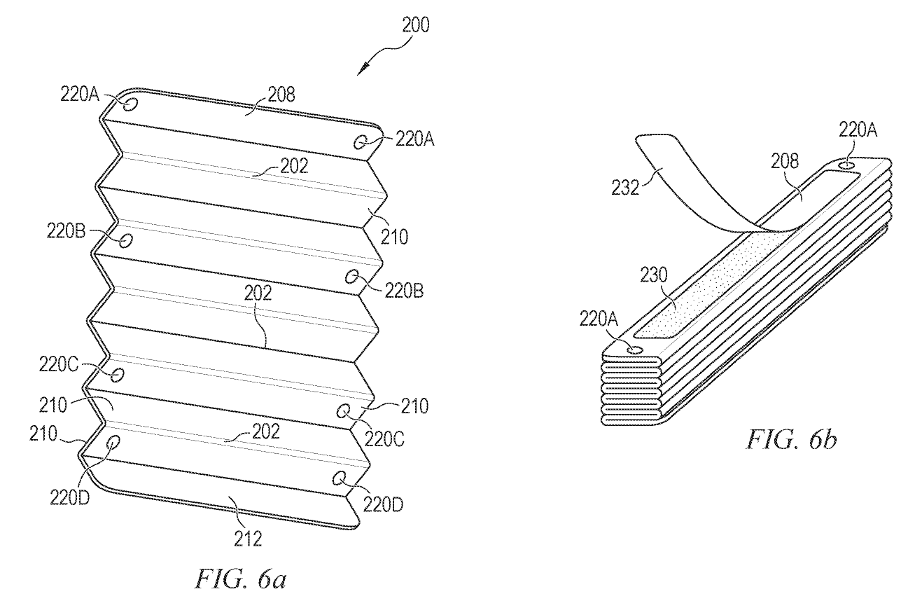

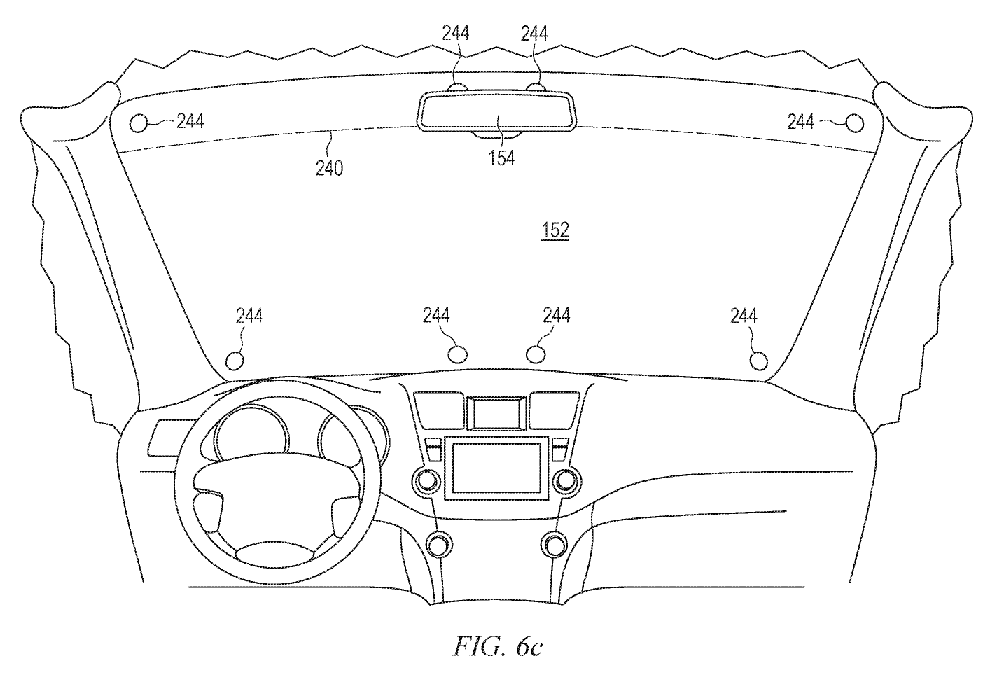

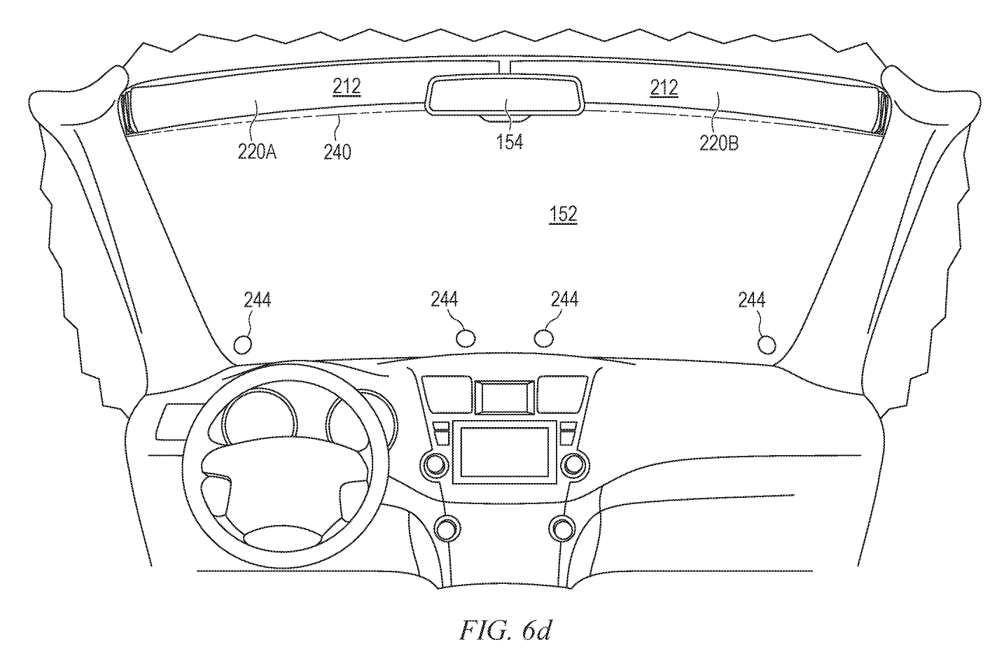

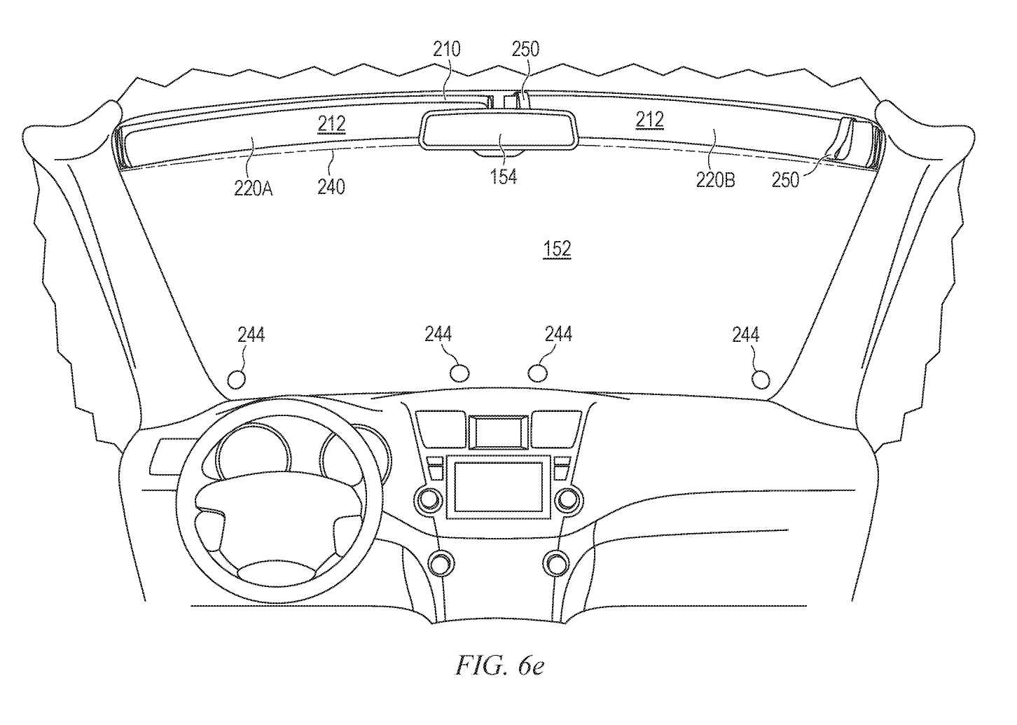

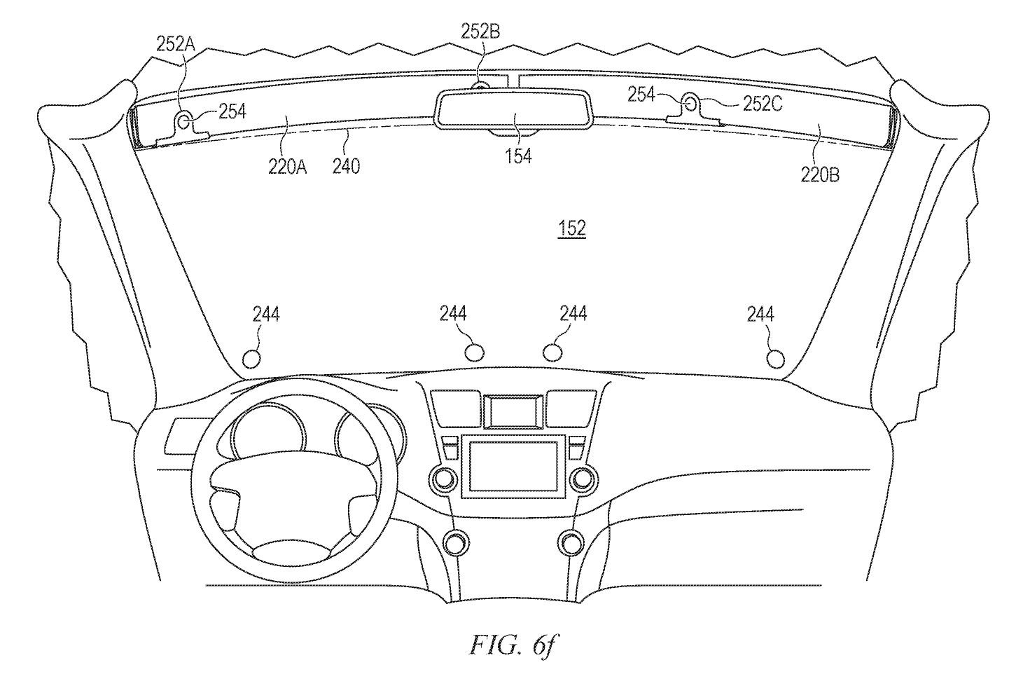

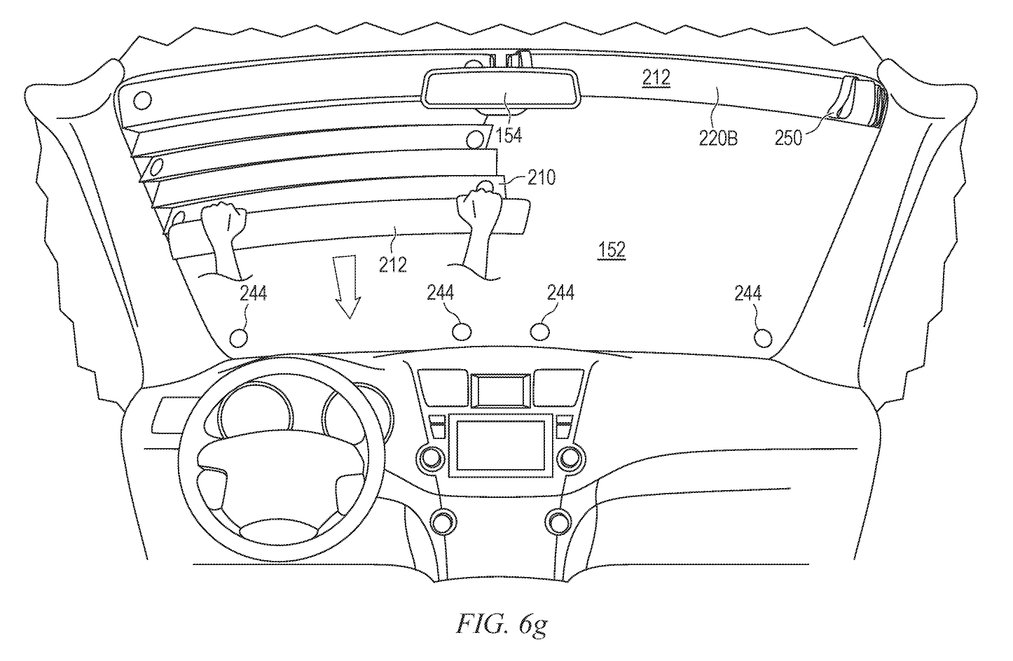

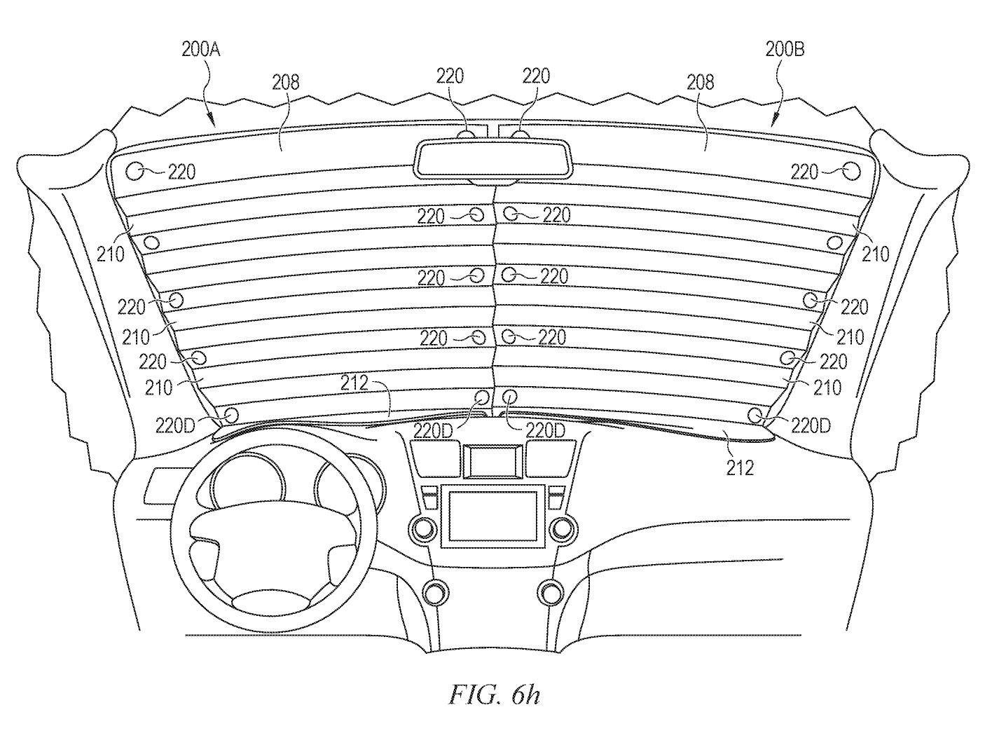

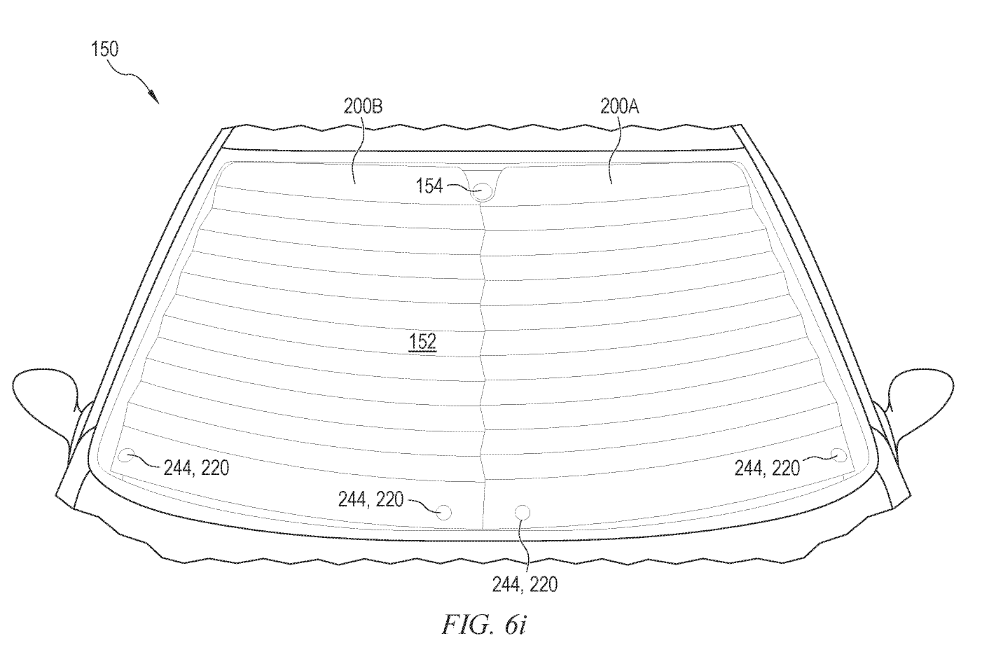

FIGS. 6a-6i illustrate a sun shade designed to be left attached in windshield 152 when the vehicle is being driven and the sun shade is not deployed. FIG. 6a illustrates an accordion style sun shade 200. Sun shade 200 includes a plurality of horizontally oriented folds 202 that separate the sun shade into a plurality of flat sections 208, 210, and 212. Sun shade 200 is formed of similar materials and in a similar manner as sun shades 10 and 110 above. Folds 202 are formed in sun shade 200 in a similar manner to folding lines 30 above. Folds 202 are formed in alternating directions so that, when sun shade 200 is folded up, each of the sections 208-212 is approximately uniform size and stacked neatly.

Some of the sections 208-212 include attachment mechanisms 220. In other embodiments, more or less of the sections 208-212 can have attachment mechanisms 220, including up to every section. As illustrated, top section 208 includes attachment mechanisms 220a, and attachment mechanisms 220b, 220c, and 220d are distributed among the middle sections 210. Bottom section 212 is used as a handle for sun shade 200 in some embodiments, and has no attachment mechanisms so that the bottom section hangs down for easy gripping. In other embodiments, bottom section 212 includes attachment mechanisms configured to allow easy gripping of the bottom section.

In one embodiment, attachment mechanisms 220a of top section 208 are magnets, and each of the attachment mechanisms 220b-220d are pieces of metal that are attracted to the magnets when in proximity. Other suitable attachment mechanisms, including any of those mentioned above, may be used in other embodiments.

Attachment mechanisms 220 keep shade 200 folded up, as in FIG. 6b, until a user applies a force to separate the magnets and metal components, or otherwise disengages the attachment mechanisms. Disengaging attachment mechanisms 220 allows sun shade 200 to be stretched over windshield 152. In one embodiment, top section 208 of sun shade 200 is attached to the top of a windshield. A user grabs bottom section 212 and stretches sun shade 200 down to the bottom of windshield 152 while the top section remains attached to the top of the windshield. Sun shade 200 is mounted to windshield 152 by an adhesive layer 230 in one embodiment. To mount sun shade 200 onto windshield 152, adhesive layer 230 is exposed by removing a protective sheet 232 from top section 208.

FIG. 6c illustrates the inside of windshield 152. Vehicle windshields include a line 240, sometimes referred to as an AS1 line, above which the driver's view through the windshield can legally be blocked. Sun shade 200 can be sized to fit within the area of windshield 152 above AS1 line 240 to comply with regulatory requirements.

If adhesive layer 230 is being used to install sun shade 200, sheet 232 is removed and the shade is stuck to windshield 152 within the AS1 area. In other embodiments, windshield 152 includes attachment mechanisms 244 across the top of the windshield to attach sun shade 200. In one embodiment, attachment mechanisms 244 are metal pieces similar to attachment mechanisms 220b-220d on sun shade 200. Attachment mechanisms 244 can be larger, or a different metal, so that the magnetic attraction of attachment mechanisms 220a to the windshield is significantly stronger than the attraction of attachment mechanisms 220b-220d. That way, the sun shade can be deployed by separating attachment mechanisms 220b-220d without separating attachment mechanism 220a from the windshield. In other embodiments, attachment mechanisms 244 are hooks that extend through openings in top section 208 when sun shade 200 is installed on windshield 152. Any other suitable attachment mechanism is used in other embodiments. Attachment mechanisms 244 at the bottom of the windshield are used to hold the bottom of sun shade 200 while deployed.

In most embodiments, sun shade 200 is split into two sections, one on each side of rear view mirror 154. A user takes two of the sun shades 200 in FIG. 2b, and sticks one in the AS1 area on each side of rear view mirror 154. FIG. 6d illustrates two sun shades 200a and 200b installed on windshield 152, either by adhesive 230, magnetism, or another attachment mechanism. Sun shades 200a and 200b are folded up so that a driver can see through windshield 152. Therefore, the bottom section 212 of each sun shade 200 is visible.

A manufacturer has various options for ensuring that bottom section 212 is easy to grasp for deployment of sun shades 200. FIG. 6e illustrates two possibilities. Sun shade 200a has bottom section 212 configured so that bottom section 212 sags slightly. The sag in bottom section 212 allows a small gap between the bottom section and middle sections 210 that a user can insert fingers into to grab the bottom section. Bottom section 212 can be made of a more flexible material than the other sections to allow for a sag. Bottom section 212 can include attachment mechanisms that are placed slightly outward from the other attachment mechanisms 220 such that the edges of bottom section 212 are pulled in slightly as illustrated. Sun shade 200b has handles 250 to deploy the sun shade in addition to, or instead of, bottom section 212.

FIG. 6f illustrates another gripping mechanism, tabs 252. Tabs 252 include attachment mechanisms 254 for holding the tabs against the rest of the shade and out of the way. The attachment mechanism can be magnet, metal, snap fit, button, Velcro, or any other method of fastening to keep the tab out of the driver's field of view and provide a clean and aesthetic appearance. Each shade 200 can include one tab 252 centered as with tab 252c of shade 200b, or can include multiple tabs. Tabs 252a and 252b of shade 200a are aligned with underlying attachment mechanisms 220 to piggyback on the magnetic attraction already provided. Any number and configuration of tabs 252 can be used. Tabs 252 can be used on any of the above or below sun shade embodiments.

FIG. 6g illustrates a user in the process of deploying sun shade 200a. The user grabs bottom section 212 with his or her hands and pulls down. The force applied by hand separates attachment mechanisms 220, but top section 208 remains attached to the top of windshield 152. Top section 208 stays attached to windshield 152 based on the attachment being stronger than with middle sections 210, e.g., a stronger magnetic force or an adhesive that is stronger than the magnetic force holding the middle sections. The user stretches down bottom section 212 to the bottom of windshield 152 and lines up attachment mechanisms 220d with the attachment mechanisms 244 on the bottom of the windshield. In some embodiments, additional attachment mechanisms 244 on windshield 152 align with and attach to attachment mechanisms 220b and 220c of sun shades 200.

Attachment mechanisms 244 hold shades 200 to the bottom of windshield 152 while top section 208 remains attached at the top of the windshield to substantially block sunlight. The user performs the same action with the second sun shade 200b to block sun for the entire windshield 152. FIGS. 6h and 6i illustrate sun shades 200a and 200b fully deployed. FIG. 6h illustrates the view from the inside of the vehicle. Bottom section 212 remains loose for easy grasping when a user is ready to put up sun shades 200. In other embodiments, there is a handle or other type of flap for the user to grab and put up sun shades 200. In some embodiments, a user grabs the bottom-most middle section 210 that is stuck to windshield 152 without an additional gripping device provided.

FIG. 6i illustrates sun shades 200a and 200b deployed from the exterior of the vehicle. Attachment mechanisms 244 at the bottom of windshield are visible through the windshield. Additional attachment mechanisms 244 are visible in other embodiments where used to hold top section 208 or additional middle sections 210. In embodiments where a windshield 152 is wider at the bottom than the top, shades 200 can be made with a similar shape as the windshield. When folded up, the stack of sections 208-212 expands as the stack moves away from windshield 152. The vehicle's A-pillar is rounded and provides relief for the wider sections farther from the windshield.

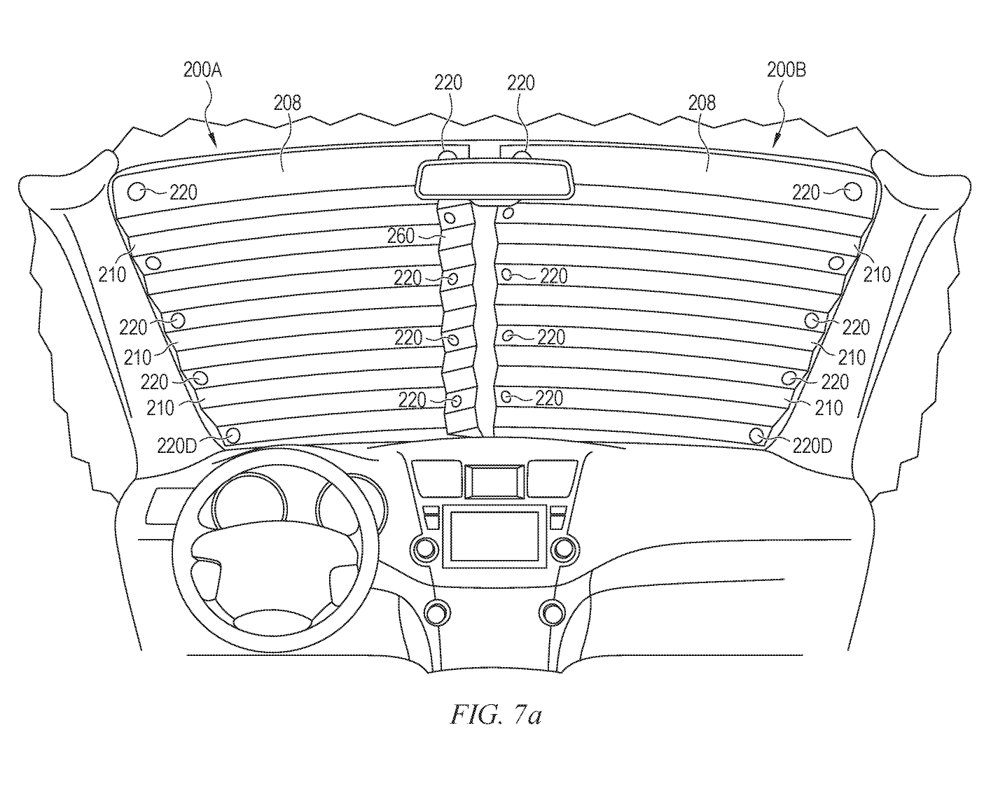

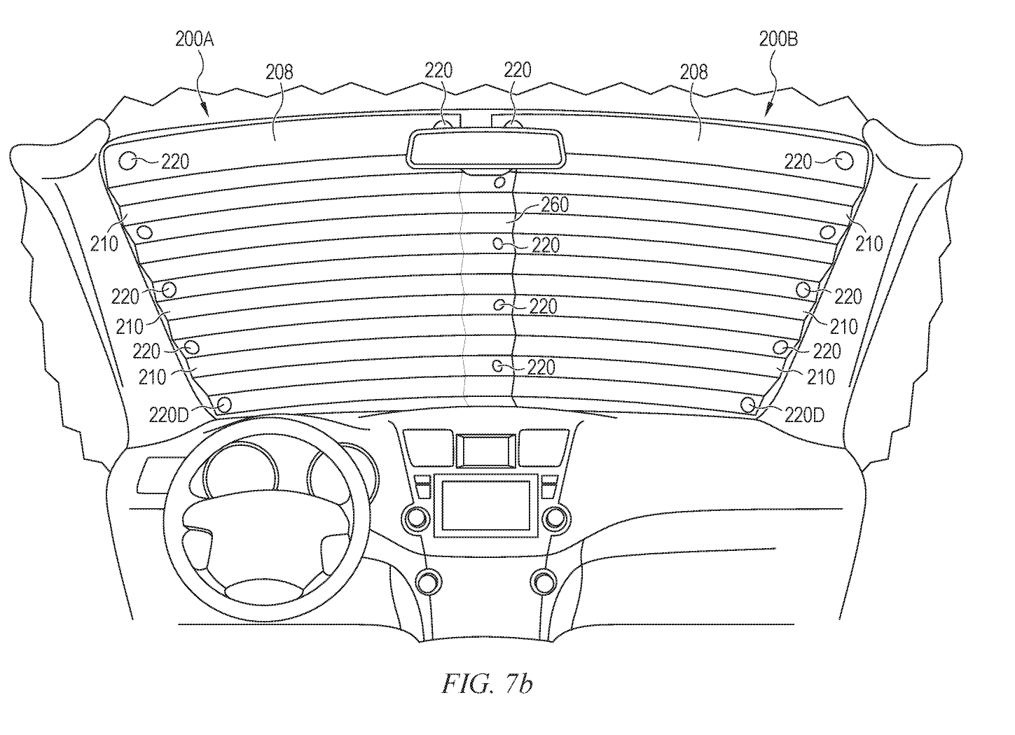

FIGS. 7a and 7b illustrate a sun shade flap used to fill a gap between two adjacent sun shades. FIG. 7a illustrates sun shades 200a and 200b deployed in windshield 152. Sun shade 200a includes a flap 260 along the right side of the sun shade. Flap 260 can be folded over to the right, as illustrated in FIG. 7b, to overlap with sun shade 200b during deployment of the sun shades, or folded over to the left, as illustrated in FIG. 7a, to be folded up with sun shade 200a. Attachment mechanisms 220 of sun shade 200a are within flap 260.

When flap 260 is flipped to the right, attachment mechanisms 220 of sun shades 200a and 200b are aligned with each other and keep the flap deployed. Attachment mechanisms 220 can be magnetic or mechanical. Shade 200a can include metal attachments 220 and shade 200b can include magnetic attachments 220, so that the two attach with each other. Attachment mechanisms 220a in both shades can be magnetic so that the metal attachments of shade 200a attach to the top attachment mechanism 220a, and the magnetic attachments of the right shade 200b also attach to the top magnetic attachment.

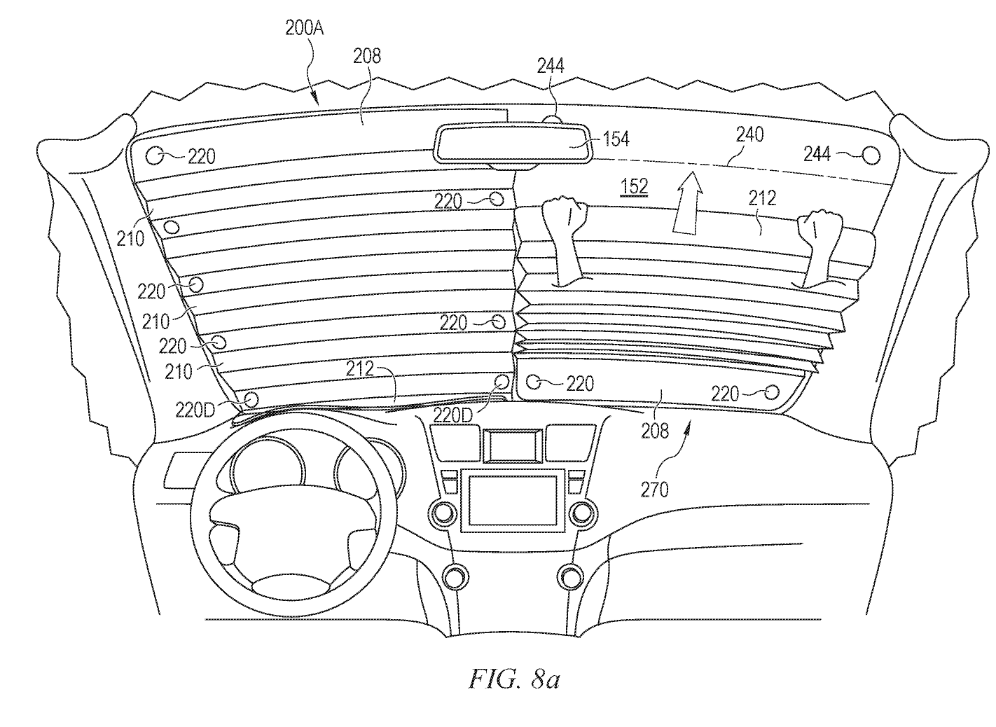

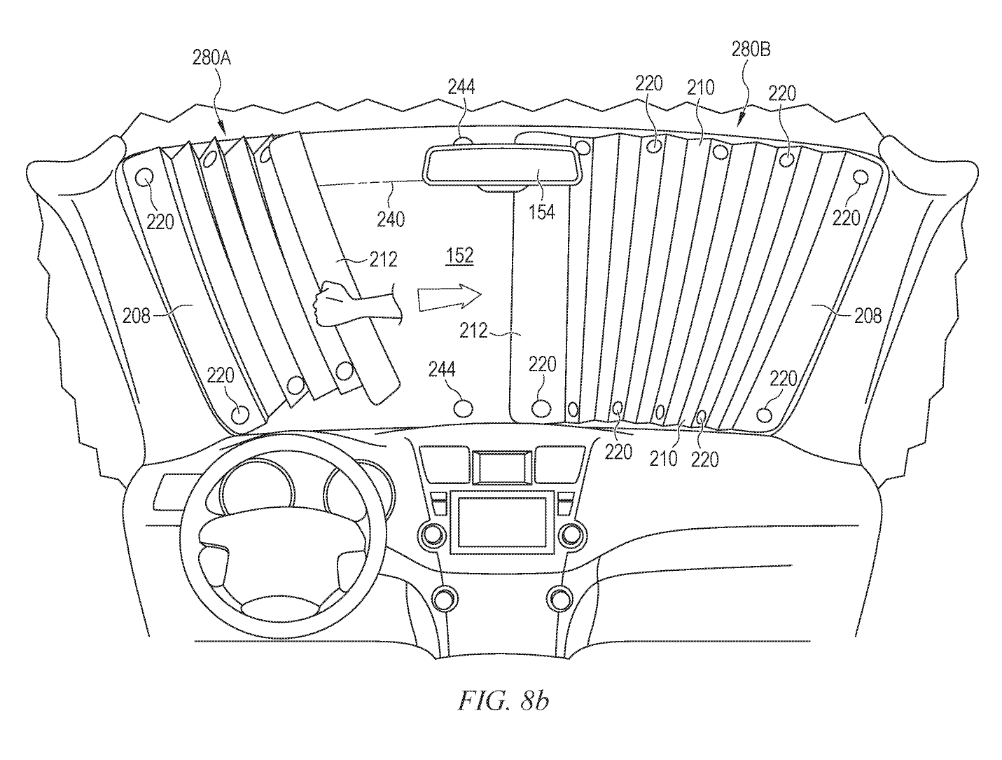

FIGS. 8a and 8b illustrate alternative mounting locations for sun shades in windshield 152. FIG. 8a illustrates an embodiment with one of the two sun shades mounted on the bottom of windshield 152. The driver's side shade 200a remains attached by section 208 at the top of windshield 152 as before. Passenger's side shade 270 is mounted at the bottom of windshield 152. A user stretches shade 270 from bottom to top of windshield 152 to attach the windshield to the attachment mechanisms 244 at the top of the windshield.

In the split sun shade embodiment, sun shades can be attached to the bottom and top of the windshield in any combination, e.g., both on top, both on bottom, or only the driver's side on bottom. Sun shade 270 mounted to the bottom of the windshield operates like sun shade 200 in other respects, but is simply mounted in a different location. The sun shades can have perfectly vertical edges in the middle of windshield 152, or the edges can be sloped either toward each other or in the same direction. The shades can overlap or not overlap. In some embodiments, the sun shades are mounted to the dashboard or roof of the car rather than the windshield.

FIG. 8b illustrates an embodiment with sun shades 280a and 280b mounted vertically near the A-pillars of the vehicle. To deploy sun shades 280, sun shade 280a is stretched from the left side of the windshield to the middle, and sun shade 280b is stretched from the right side of the windshield to the middle. Sun shades 280 can attach to a common set of attachment mechanisms 240 at the center of windshield 152, or each sun shade can have its own separate attachment mechanisms. The edges of sun shades 280 at the center of the windshield can be sloped in the same direction, sloped in opposite directions, or vertical. Sun shades 280 can be mounted to windshield 152 or mounted to the A-pillars adjacent to the windshield.

While the above sun-shades are illustrated as mounted onto the windshield and having an expansion provided by being accordion folded, other expansion mechanisms are used in other embodiments. For instance, the shades could be mounted to the windshield in a rolled-up state and unrolled to expand and cover up the windshield. The shades could also be elastic, or allow for expansion across a windshield by any other mechanism.

While one or more embodiments of the present invention have been illustrated in detail, the skilled artisan will appreciate that modifications and adaptations to those embodiments may be made without departing from the scope of the present invention.

What is claimed:

1. A sun shade, comprising:
a substrate;
a folding line formed in the substrate;
a first attachment mechanism disposed over the substrate on a first side of the folding line; and
a second attachment mechanism disposed over the substrate on a second side of the folding line.

2. The sun shade of claim 1, wherein the first attachment mechanism includes a magnet.

3. The sun shade of claim 1, wherein the first attachment mechanism includes a ferrous material.

4. The sun shade of claim 1, further including a third attachment mechanism separate from the sun shade and configured to attach to the first attachment mechanism.

5. The sun shade of claim 1, wherein the first attachment mechanism and second attachment mechanism are located symmetrically across the folding line.

6. The sun shade of claim 1, wherein the substrate further includes a flap oriented substantially perpendicular to the folding line.

7. The sun shade of claim 1, further including an adhesive layer disposed over a portion of the substrate.

8. A sun shade, comprising:
a substrate;
a first attachment mechanism; and
a second attachment mechanism, wherein the first attachment mechanism is configured to attach to the second attachment mechanism.

9. The sun shade of claim 8, further including a third attachment mechanism configured to mount the sun shade.

10. The sun shade of claim 9, wherein the third attachment mechanism is an adhesive layer disposed over the substrate.

11. The sun shade of claim 9, wherein the third attachment mechanism is mounted on a windshield of a vehicle.

12. The sun shade of claim 9, wherein the third attachment mechanism is configured to attach to the first attachment mechanism.

13. The sun shade of claim 8, wherein the first attachment mechanism is a magnet.

14. The sun shade of claim 8, further including an indicator disposed over the substrate adjacent to the first attachment mechanism.

15. A method of reducing sunlight entering a vehicle, comprising:
providing a first sun shade including a first attachment mechanism disposed over the first sun shade;
mounting a second attachment mechanism to a first location on a windshield;
mounting the first sun shade to a second location on the windshield; and
expanding the first sun shade to attach the first attachment mechanism to the second attachment mechanism.

16. The method of claim 15, wherein mounting the first sun shade to a second location on the windshield is with an adhesive.

17. The method of claim 15, further including mounting a second sun shade to the windshield adjacent to the first sun shade.

18. The method of claim 17, further including unfolding a flap of the first sun shade to overlap the second sun shade.

19. The method of claim 15, further including retracting the first sun shade, wherein a third attachment mechanism of the first sun shade attaches to the first attachment mechanism.

20. The method of claim 15, further including mounting the second attachment mechanism to the windshield using a template.
